(19) United States
(12) Patent Application Publication
(10) Pub. No.: US 2023/0277947 A1
(43) Pub. Date: Sep. 7, 2023

(54) TREND-BASED GUESSING GAME

(71) Applicant: William G. DiSessa, Holly, MI (US)

(72) Inventor: William G. DiSessa, Holly, MI (US)

(21) Appl. No.: 17/684,372

(22) Filed: Mar. 1, 2022

(51) Int. Cl. A63F 13/80; A63F 13/26; A63F 13/327; A63F 13/46

(52) U.S. Cl. CPC A63F 13/80; A63F 13/26; A63F 13/327; A63F 13/46; A63F 2300/8094; A63F 2300/301; A63F 2300/405; A63F 2300/61

(57) ABSTRACT

A system for a trend-based guessing game includes an electronic communication and display device, configured with software to enable the electronic communication and display device to communicate with a cloud server that accesses a trend database to download a trend. The system also includes a pair of glasses configured to be worn by a user, the glasses including communication and display driver electronics and a glasses electronic display configured to display the downloaded trend on the glasses electronic display, the glasses electronic display configured such that the user cannot read the display when wearing the glasses.

### BACKGROUND

Conventionally, numerous word-, name-, and phrase-guessing games exist in which one or more participants are tasked with guessing the word, name, or phrase that is known by another participant or another group of participants who provide clues to the guessing participants about what the word, name, or phrase may be. Various rules may dictate how clues are given or put limitations on the content of the clues that are given. For example, the clues may have to be single words, or the clues might have to avoid using any words that are in the target word, name, or phrase.

Some of the conventional games may use cards or simple, static electronic displays to provide the target word, name, or phrase to the clue providers. Many of these games provide targets which may be in a specific category (e.g., entertainment, science, history, etc.).

These conventional games often suffer from targets that are static because they are printed on a deck of cards or stored in a database that is not often changed or updated. Further, the group of targets may not have any relevance to things of interest to the players.

Accordingly, it may be advantageous to provide a game which generates targets that are interesting to game participants and that provide targets that are dynamic and change with time to the interests of the participants and that participants may even learn from.

### SUMMARY OF THE INVENTION

Various embodiments relate to a system for playing a game. The system includes an electronic communication and display device, configured with software to enable the electronic communication and display device to communicate with a cloud server that accesses a trend database to download a trend. The system also includes a pair of glasses configured to be worn by a user, the glasses including wireless communication and display driver electronics and a glasses electronic display configured to display the downloaded trend on the glasses electronic display, the glasses electronic display configured such that the user cannot read the display when wearing the glasses.

Other various embodiments also relate to a method of playing a game. The method includes receiving, by an electronic device from a cloud server, a trend. The method also includes sending, from the electronic device to a display device, the trend. Further, the method includes displaying the trend on the display device in such a way that a subset of players of a group of players is obscured from seeing the displayed trend.

Further, various embodiments relate to a method of providing trends to a trend-based game. The method includes receiving periodically, by a cloud server from a trend service, a plurality of trends. The method also includes storing the plurality of trends in a database. The method further includes providing one or more trends from the database and by the cloud server to an electronic device in response to a command from the electronic device.

### BRIEF DESCRIPTION OF THE DRAWINGS

FIG. 1 is an exemplary game flow diagram for a trend-based guessing game.

FIG. 2 is an exemplary visual overview of the above hub-and-spoke system for accessing and downloading the trends to a game cloud database.

FIG. 3 is an exemplary depiction of a system configured for the trend-based guessing game of FIG. 1.

FIG. 4. Is an exemplary depiction of two examples of Light Emitting Diode (LED) glasses products on the market that may be configured for the trend-based guessing game of FIG. 1.

### DETAILED DESCRIPTION OF THE INVENTION

In the following detailed description, reference is made to the accompanying drawings, which form a part thereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

In accordance with various embodiments the game may include a 1) mobile app for two or more players, who can play in the same location or virtually in multiple locations; and 2) one or more pairs of the game's scrolling LED glasses or other electronic display devices (the electronic display may, in some embodiments, be the same display device that the app is running on) that provide the target to be guessed to the clue givers.

In accordance with various embodiments, the targets that may be displayed may include present trends. For example, such trends may be derived from Google Trends (https://trends.google.com/trends/?geo=US) or other trend sites such as but not limited to Google Trends, Google Trends Annual (e.g., 2019), Trendify (https://trendifyapp.com/), Yahoo! News Trending Now (https://news.yahoo.com/tagged/trending-now/), BuzzFeed Quizzes (https://www.buzzfeed.com/quizzes), etc. The trends may be derived in various ways but typically reflect what people are interested in. For example, Google Trends provides trends that are related to the most popular searches recently.

In the case that only one pair of LED glasses is available at a location, players may take turns wearing the glasses and attempting to guess the target. Any players at other locations must also have at least one pair of the game's LED glasses on hand in order to play virtually. Of course, each player may use his or her own glasses if available.

The main source for the trends may be but is not limited to Google Trends. One or two other options for trend sources may also be available as back-ups or as alternative choices in the app. These choices may be listed in the Rules file or other places in the app interface. Trends may be fed to the app via an internet connection to Google Trends' server and its application programming interface (API) or the like.

The app then parses the trends, as necessary, and displays them on the app screen in a sleek, easy-to-read way. A “dealer” player optionally picks a trend to display on the LED glasses of the guessing player, or the app automatically selects the next available trend from a Google Trends list.

Once a trend is selected by the dealer player or the app, the trend scrolls across the guessing player's LED glasses or is displayed on a display device. Competing players then shout clues to the guessing player and he or she in turn shouts out guesses to the clues. If the player guesses correctly before the app timer expires, he or she is awarded 1 point, while one point is deducted for an incorrect guess as time expires. The dealer or another player tells the app the player answered correctly or incorrectly, and the app then logs the score, and continues to do so for each player.

If a player passes on a question, zero points may be awarded, and the next player takes a turn guessing. Alternately, a player may pass up to three times per turn guessing, and one point is deducted for each pass. So, in that instance, a player's score is −3 in his turn if he passes all three times and does not correctly guess a trend before the timer lapses. Other penalty and scoring rules may be applied without departing from the scope of the disclosure.

In various embodiments optionally, players may check a box in game settings to disallow the option to pass during a game.

If the app timer expires before an answer, no points are awarded, and the next player dons the LED glasses and takes a turn guessing.

In accordance with various embodiments, the first player to 3 points wins the game. Alternately, the app may allow players to set the default winning score from 3 to, say, 20 points.

It should be noted that the rules of the game may be varied without departing from the scope of the disclosure.

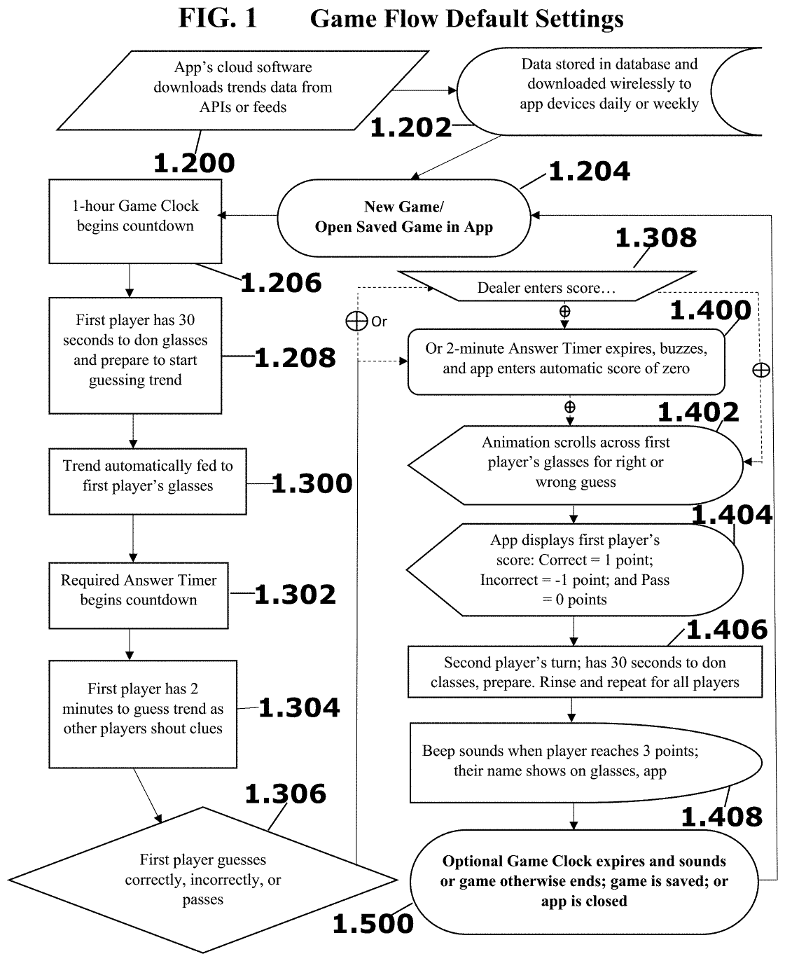

Referring now to FIG. 1, an exemplary game flow diagram is provided for a trend-based guessing game. An app or other program uses cloud interactive software which downloads trends data from an API (such as but not limited to a Google Trends API, etc.) or other information feeds (Process 1.200). Data retrieved may be stored in a database and downloaded wirelessly or otherwise to app devices on a periodic basis (such as but not limited to Daily or weekly, etc.)

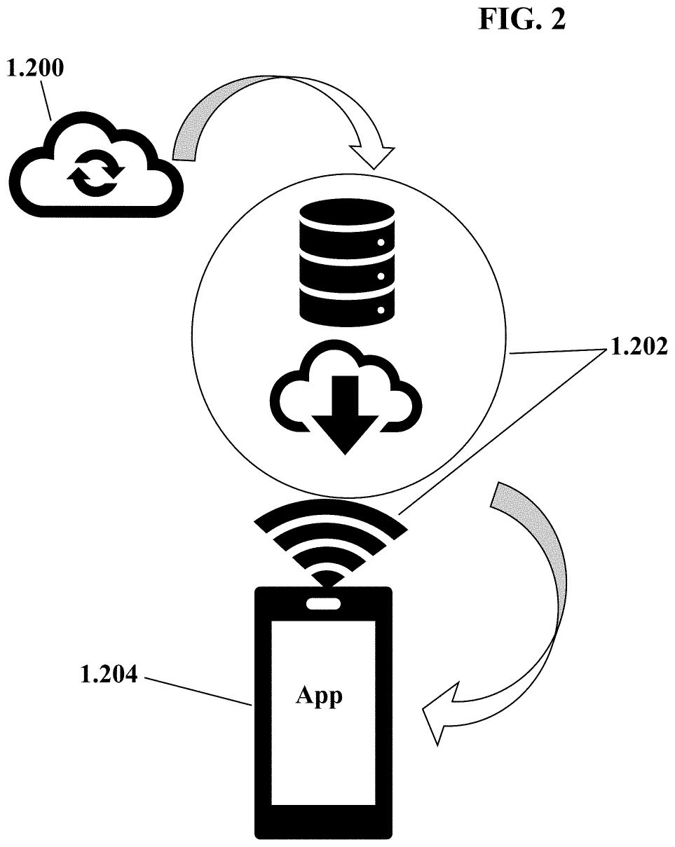

Referring to FIG. 2, the game utilizes a hub-and-spoke type system whereby the Trends system feeds a cloud database through an API or the like (Process 1.200). These downloads occur in the background, though the app may sometimes display a note to players to pause while the game briefly updates its trends repository. The downloaded trends are stored in a cloud database. The game app then wirelessly accesses its cloud database, downloads the trends to the app, and displays them on the app screen for players (Process 1.202). This system elegantly avoids a bandwidth-choking scenario where hundreds of players' apps are each accessing Google Trends (or another source) directly.

Using this hub-and-spoke structure avoids any Google Trends (or other trend sources) bandwidth restrictions. Further, in accordance with various embodiments it may also be designed in such a way that each player's app may access Google Trends (or other trends sources) directly if bandwidth is not an issue.

If bandwidth ever becomes an issue, the above hub-and-spoke system may be used as the main embodiment.

Referring again to FIG. 1, the gameflow begins at starting a new game or opening a saved game in the app (process 1.204). In accordance with an exemplary embodiment, a 1-hour (or any game time limit) Game Clock begins a countdown (process 1.206). A first player is then given 30 seconds to don the glasses and prepare to start guessing the trend (process 1.208). The trend which has been downloaded from the Trend source is then fed to a first player's glasses or other display devices (process 1.300). At that point an Answer Countdown Timer is started, for example 120 seconds or the like (process 1.302). The first player, during the two-minute countdown interval, tries to guess the trend as other players shout out clues (process 1.304). During the time interval the first player guesses correctly, incorrectly, or passes (process 1.306). Once the interval is over or the player has guessed the correct Trend, the dealer enters the score (process 1.308) or alternatively the two-minute answer timer expires, buzzes, and the app enters the score of zero automatically (process 1.400). In various embodiments, an animation may scroll across the first player's glasses for a right or wrong guess (process 1.402) and the app displays a first player's score which may be, for example, 1 point for a correct answer, −1 point for an incorrect answer and 0 points for a pass (process 1.404). Other scoring methodologies may also be used without departing from the scope of the disclosure. Next, a player is then provided 30 seconds to don the glasses or otherwise prepare to play the game (process 1.406) and the game play is repeated with the second player. When a player reaches 3 points, the app begins a game end routine which may include providing an end game sound and display of the winner's name e.g. (process 1.408). In some cases, a player might not reach 3 points and the Game Clock will end. The game may be saved, and a winner determined before the app is closed (process 1.500).

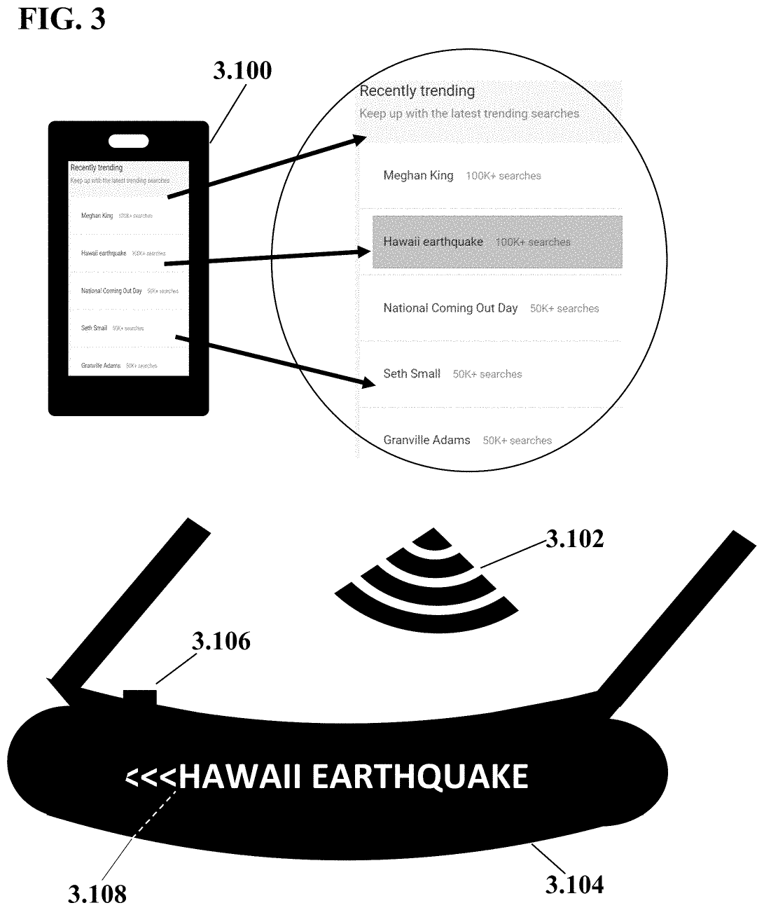

Referring now to FIG. 3, the game app provides a display interface 3.100 showing various Trends that a participant can choose from for the player wearing the glasses to guess. Once the Trend is selected, the app provides a wireless signal either directly, such as over Bluetooth or over a Wi-Fi connection 3.102 or further if the glasses are being used by a remote participant, over an internet connection or the like.

A set of display glasses 3.104 or other display devices displays the Trend 3.108 which may scroll across the screen or display in other ways. The glasses may contain an LED screen or any other type of outward-facing electronic display. The app repeats this same process for each subsequent player until one player wins the game or the game is stopped/saved/canceled.

In accordance with various embodiments, glasses 3.104 may include an electronics package including but not limited to a wireless receiver, processing electronics configured to receive and display information on the glasses display 3.108, battery charging ports, and associated charging electronics. Players may pass the glasses to each other when it's their turn to guess a trend, or individual players each may use their own pair. The game app's programming allows and adjusts for one to multiple pairs of glasses, each of which contain a microchip for wireless communications with the app.

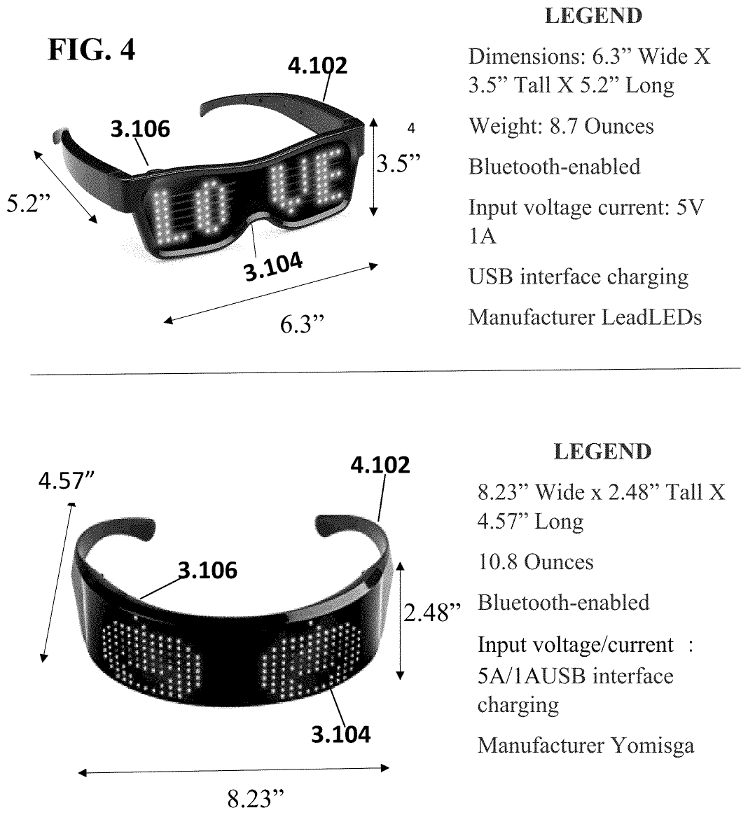

Referring now to FIG. 4, two example glasses 4.102 having displays 3.104 are depicted. Each of these glasses function in such a way that the wearer can see through the glasses but cannot see what is on the display. Each of these glasses 4.102 is configured to use a Bluetooth connection to receive the display information.

In accordance with exemplary embodiments, game play begins by setting a timer for two minutes and having the first player wear the game's LED glasses. The player wearing glasses is hereafter known as the guessing player. A trend (person, place, or thing in the form of a keyword or key phrase) then displays on the glasses, which only can be seen by other players. Those players then yell out clues for the guessing player. Without looking at the app on their phone or, obviously, the front of the glasses, the first player continues to guess what's on their glasses until correct, until they decide to pass, or until time expires. Repeat with players two, three, etc.

If the clue-giving player or players don't know enough about the trend to give clues, the app may link each Trend keyword/key phrase to its Wikipedia entry. If there is no entry, in Wikipedia, other websites may be accessed for more information via the app.

Once the game starts, it may be designed to run in an automated mode. For example, when the Start button is pushed, the app may be configured to automatically pick a trend from the Trend feed and the first player is given 30 seconds to put on the glasses and prepare to start guessing. Each subsequent player has the same time, 30 seconds, to don the glasses and prepare.

Any player except the guessing player may pause the game/timer at any time by clicking the app's Pause button.

In accordance with various embodiments, a correct answer=1 point; failing to correctly answer timely=−1 point; and passing before the two-minutes timer=0 points. The first player to reach 3 points wins the game and in the automated mode play is automatically stopped. For longer games, the game may be configured to be customizable—choosing, for example, 5 or 10 winning points in Settings. Various embodiments may include the ability to set an optional game timer such that when the timer expires, the player or players with the highest score wins.

Various embodiments provide functionality for player accounts and when players are logged in, their names may be listed in the app's game, and each player may enter and keep tabs of their scores. If players are not logged in, players are numbered generically, e.g., 1, 2, 3, etc., and each player remembers their number. Each guessing player or game dealer enters their score under their number.

In large groups, the gameplay is typically more spontaneous and looser. Each person takes turn wearing the glasses and, once the Trend appears, the player has 60 seconds to try to guess it.

Any of the players can keep score using the above points system or just play without keeping score.

A working title of this game and included app is LEDs-Up, a word play on the game Heads-Up, where players take turns guessing a clue card fastened to their foreheads by competitors.

### Features and Settings for App

The app enabling the gameplay described above may include any combination of the below features and functionality without departing from the scope of the disclosure.

a) Create Account/Log-In
Each player may be logged in to game accounts to maximize game experience.
Dealer (optional) also may be logged in and identified.
Log-in may be through Facebook, Google+ or gmail, or the app itself.

b) Single Location or Remote

Checkboxes for same location or from, e.g., two to 17 remote locations (if remote is selected, then each player must wear their own glasses). In the maximum number of locations, the number of allowed players would total 16 (up to 4 teams with 4 players each), plus an optional dealer.

Remote play may be enabled by using each player's mobile device cameras; players can read the glasses' scrolling text either via the guessing player's mobile device camera or via the app interface. This functionality may be provided as a Premium option to players.

Trends may be sourced from any of a variety of sources including but not limited to one or more of the following:
Google Trends
Google Trends Annual (e.g., 2019)
Trendify
Yahoo! News Trending Now
Buzz Feed Quizzes (possible use as tiebreaker)

Trend Feed

Checkboxes for Automatic and Manual mode may be selected. If Manual is selected, then someone must be “dealer” who picks trends and feeds them to each guessing player's glasses. The dealer cannot be a player because he or she otherwise would have the advantage of seeing other trends listed or at least the trend displayed in the app when it's their turn to guess.

Dealer

If Manual Trend Feed is selected, then a dealer name is selected among the logged-in players. Once a dealer is selected, the app prevents him or her from competing by not listing them as a player.

Animations on Glasses

In accordance with various embodiments, the glasses may provide various animations in various circumstances. For example, correct answers may produce balloons, fireworks, flashing text, etc. Incorrect answers may produce sad face, clown face, etc. After a player's score is entered into the app, “Next Up!” or some other indicator may be displayed on the glasses to indicate that it is the next player's turn to become the guessing player. In some embodiments, the glasses may be configured to play audio sounds in different circumstances as well.

Winning Score

Various scoring options may be provided for example, scoring options may include but are not limited to: Don't keep score; 3 points (default); 5 points; or 10 points.

Game Timer

Options may include the use of a game timer. The game timer may range from 1 minute to 2 hours for example, if enabled. In various embodiments, one hour may be default. When game timer expires, it rings or provides another end indicator.

Answer Timer

Options may include the selection of an answer time. The answer time may range from 15 seconds to 5 minutes; player has 2 minutes to guess trend by default. When the answer timer expires, it buzzes or provides another end indicator. The Answer timer stops once the player's score is entered. The Next Player timer then starts, and the Answer Timer resets, starting anew when the Next Player timer expires.

Next Player Timer

Options may include the selection of a next player timer. If enabled, the time for the next guessing player to don glasses and to start guessing ranges from 10 seconds to 3 minutes, for example; 30 seconds is the default.

Selecting this option in combination with Automatic Feed pushes the game forward on autopilot.

Guessing Player Order

Options may include the selection for Random or Alphabetical player order, based on logged-in players' account names

Advantages

In accordance with various embodiments, the game allows players to compete in person and/or online via a mobile app.

Trends are continuously updated by their source providers, making for an improved game experience with evergreen content of an educational nature beneficial to players. Further, there is no need for players to buy game updates or later versions.

The scrolling LED glasses, which contains a programmable microchip for communicating wirelessly with the mobile app, adds an exciting and interactive touch to play. Also, the glasses can help announce/celebrate/motivate/encourage correct answers and razz wrong ones.

As the game app allows players (not the one guessing) to look up the meaning of a Trend, it's also educational in more than one way.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g., “configured to”) generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

What is claimed is:

1. A system for playing a game, comprising:
an electronic communication and display device, configured with software to enable the electronic communication and display device to communicate with a cloud server that accesses a trend database to download a trend;
a pair of glasses configured to be worn by a user, the glasses including communication and display driver electronics and a glasses electronic display configured to display the downloaded trend on the glasses electronic display, the glasses electronic display configured such that the user cannot read the display when wearing the glasses.

2. The system of claim 1, wherein the electronic communication and display device includes a mobile phone.

3. The system of claim 1, wherein the electronic communication and display device includes a tablet computer.

4. The system of claim 1, wherein the electronic communication and display device includes a wireless communication connection configured to access the internet via the wireless communication connection.

5. The system of claim 1, wherein the electronic communication and display device includes a Wi-Fi connection configured to access the internet via the Wi-Fi connection.

6. The system of claim 1, wherein the glasses communication electronics include a Wi-Fi microchip.

7. The system of claim 1, wherein the glasses communication electronics include a Bluetooth microchip.

8. The system of claim 1, wherein the glasses electronic display includes a Light Emitting Diode (LED) based display

9. The system of claim 1, wherein the cloud server is configured to periodically retrieve one or more trends from a Trend source.

10. The system of claim 1, wherein the cloud server is configured to periodically retrieve more than one trend from a Trend source.

11. The system of claim 1, wherein the cloud server is configured to periodically retrieve more than one trend from more than one Trend source.

12. The system of claim 1, wherein the cloud server is configured to periodically retrieve one or more trends from Google Trends.

13. The system of claim 1, wherein the software is configured to allow choosing one trend from a plurality of trends.

14. A method of playing a game, comprising:
receiving, by an electronic device from a cloud server, a trend;
sending, from the electronic device to a display device, the trend; and
displaying the trend on the display device in such a way that a subset of players of a group of players is obscured from seeing the displayed trend.

15. The method of claim 14, further comprising:
starting an answer timer for a predetermined length of time.

16. The method of claim 14, further comprising:
tracking scoring of the game for the group of players.

17. The method of claim 14, further comprising:
receiving, by the electronic device from the cloud server, multiple trends.

18. The method of claim 17, further comprising:
selecting from the multiple trends, the trend.

19. The method of claim 14, wherein the display device includes a pair of glasses having an outward-facing electronic display.

20. A method of providing trends to a trend-based game, comprising:
receiving periodically, by a cloud server from a trend service, a plurality of trends;
storing the plurality of trends in a database; and
providing one or more trends from the database and by the cloud server to an electronic device in response to a command from the electronic device.
